(19) United States
(12) Patent Application Publication
(10) Pub. No.: US 2026/0154598 A1
(43) Pub. Date: Jun. 4, 2026

(54) QUANTUM DEVICE TESTING WITH QUANTUM ASSERTIONS

(71) Applicant: University of Florida Research Foundation, Incorporated, Gainesville, FL (US)

(72) Inventors: Prabhat MISHRA, Gainesville, FL (US); Daniel VOLYA, Gainesville, FL (US); Hasini WITHARANA, Gainesville, FL (US)

(21) Appl. No.: 18/953,481

(22) Filed: Nov. 20, 2024

Related U.S. Application Data
(60) Provisional application No. 63/619,368, filed on Jan. 10, 2024.

(51) Int. Cl. G06N 10/70; G06N 10/20

(52) U.S. Cl. CPC G06N 10/70; G06N 10/20

(57) ABSTRACT

A system includes a plurality of qubits; a qubit manipulation system for controlling evolution of respective quantum states of the qubits; a measurement system for performing measurement of qubit quantum states; and a controller for controlling operation of the qubit manipulation system and receiving measurement results from the measurement system. The controller is configured to cause the qubit manipulation system to execute a first portion of a program circuit and an assertion circuit; and receive measurement results that indicate a quantum state of an ancilla qubit used in performing a comparison test between an assertion qubit on which an assertion channel of the assertion circuit was performed and system qubits on which the first portion of the program circuit was performed. The controller is further configured to process the measurement results to determine a noise status of the system; and provide an indication of the noise status.

### CROSS-REFERENCE TO RELATED APPLICATION(S)

This application claims priority to U.S. Application No. 63/619,368, field Jan. 10, 2024, the content of which is incorporated herein by reference in its entirety.

### GOVERNMENT SUPPORT STATEMENT

This invention was made with government support under 1908131 awarded by the National Science Foundation. The government has certain rights in the invention.

### TECHNICAL FIELD

The present disclosure relates to monitoring and/or determining a noise status of a quantum computer while the quantum computer is performing a program circuit. An example embodiment relates to the use concurrent assertions to monitor and/or determine a noise status of a quantum computer while the quantum computer is performing a program circuit.

### BACKGROUND

Quantum computing can efficiently solve many hard problems significantly faster than its classical counterpart. However, quantum computers can be quite noisy. Since qubits rely on the principles of quantum mechanics, they possess an inherent small size and extreme susceptibility to environmental interactions. These interactions have the potential to introduce errors into the qubits or even completely erase the information stored by the qubits.

### BRIEF SUMMARY OF EXAMPLE EMBODIMENTS

Various embodiments provide methods, systems, apparatus, computer program products, and/or the like for determining and/or monitoring a noise status of a quantum computer during performance of a program circuit. For example, performance of the program circuit and/or portion thereof by the quantum computer may be validated based at least in part on the noise status of the quantum computer while the program circuit was performed thereby. Various embodiments use concurrent and/or runtime assertions to monitor and/or determine a noise status of a quantum computer while the quantum computer executes a program circuit. Some embodiments relate to the automated use of immediate quantum assertions for evaluating and/or improving the performance of a quantum computer.

In an example embodiment, a quantum computer includes a plurality of qubits, a qubit measurement system, a qubit manipulation system, and a controller. The qubit measurement system is configured to measure, detect, and/or read the quantum state of one or more qubits of the plurality of qubits. The qubit manipulation system is configured to manipulate the quantum state of one or more qubits. The controller is configured to control operation of the qubit manipulation system and receive input (e.g., measurement results) from the qubit measurement system. The controller is configured to obtain a program circuit to be executed by the quantum computer and obtain an assertion circuit that includes an assertion channel determined based at least in part on a first portion of the program circuit and a comparison test. The controller is further configured to cause execution of the first portion of the program circuit and the assertion circuit, receive ancilla qubit measurement results captured during the comparison test, process the ancilla qubit measurement results to determine a noise status of the quantum computer, and provide an indication of the noise status of the quantum computer.

In an example embodiment, at least one classical (e.g., semiconductor-based) processor determines the assertion circuit by obtaining a program circuit to be performed by a quantum computer; obtaining a parameterized representation of an assertion channel; initializing a set of parameters of the parameterized representation of the assertion channel; determining a difference measure between a first portion of the program circuit and the parameterized representation of the assertion circuit based on the set parameters; modifying the set of parameters based at least in part the difference measure; and determining a sequence of gates performable by the quantum computer that enact the parameterized representation of the assertion channel with a final set of parameters.

According to a first aspect, a method for monitoring noise of a quantum computer while the quantum computer is performing a program circuit is provided. The method is performed by at least one classical processor (e.g., of a controller of the quantum computer). In an example embodiment, the method includes obtaining a program circuit to be executed by the quantum computer; obtaining an assertion circuit comprising an assertion channel determined based at least on a first portion of the program circuit and a SWAP test; causing execution of the first portion of the program circuit and the assertion circuit; receiving ancilla qubit measurement results captured during the SWAP test; processing the ancilla qubit measurement results to determine a noise status of the quantum computer; and providing an indication of the noise status of the quantum computer.

According to another aspect, a system is provided. The system includes a plurality of qubits; a qubit manipulation system configured to control evolution of respective quantum states of the plurality of qubits; a measurement system configured to perform measurement of qubits of the plurality of qubits; and a controller configured to control operation of the qubit manipulation system and receive measurement results from the measurement system In an example embodiment, the controller is configured to cause the qubit manipulation system to execute a first portion of a program circuit and an assertion circuit; receive measurement results from the measurement system, the measurement result indicating a quantum state of an ancilla qubit as a result of performance of a SWAP test between the ancilla qubit, an assertion qubit on which an assertion channel of the assertion circuit was performed, and system qubits on which the first portion of the program circuit; process the measurement results to determine a noise status of the quantum computer; and provide an indication of the noise status of the quantum computer.

According to another aspect, a controller of a quantum computer is provided. In an example embodiment, the controller is configured to obtain a program circuit and an assertion circuit corresponding to a first portion of the program circuit. The controller is further configured to cause a qubit manipulation system of the quantum computer to execute the first portion of a program circuit and the assertion circuit; receive measurement results from a measurement system of the quantum computer, the measurement result indicating a quantum state of an ancilla qubit as a result of performance of a SWAP test between the ancilla qubit, an assertion qubit on which an assertion channel of the assertion circuit was performed, and system qubits on which the first portion of the program circuit; process the measurement results to determine a noise status of the quantum computer; and provide an indication of the noise status of the quantum computer.

According to another aspect, for determining an assertion circuit is provided. The method performed by at least one classical processor. In an example embodiment, the method includes obtaining at least a first portion of a program circuit to be performed by a quantum computer; obtaining a parameterized representation of an assertion channel; initializing a set of parameters of the parameterized representation of the assertion channel; determining a difference measure between a first portion of the program circuit and the parameterized representation of the assertion circuit based on the set parameters; modifying the set of parameters based at least in part the difference measure; and determining a sequence of gates performable by the quantum computer that enact the parameterized representation of the assertion channel with a final set of parameters.

According to another aspect, a classical computing entity configured for determining an assertion circuit is provided. In an example embodiment, the classical computing entity comprises at least one (semiconductor-based) processor and memory (e.g., at least one non-transitory, semiconductor-based computer storage medium) storing computer-executable instructions. The memory and the computer-executable instructions are configured to, when executed by the at least one processor, cause the classical computing entity to perform obtaining at least a first portion of a program circuit to be performed by a quantum computer; obtaining a parameterized representation of an assertion channel; initializing a set of parameters of the parameterized representation of the assertion channel; determining a difference measure between a first portion of the program circuit and the parameterized representation of the assertion circuit based on the set parameters; modifying the set of parameters based at least in part the difference measure; and determining a sequence of gates performable by the quantum computer that enact the parameterized representation of the assertion channel with a final set of parameters.

According to still another aspect, a computer program product is provided. In an example embodiment, the computer program product comprises at least one non-transitory computer-readable storage medium storing computer-executable instructions. The computer-executable instructions are configured to, when executed by one or more processors of a classical computing entity, cause the classical computing entity to perform obtaining at least a first portion of a program circuit to be performed by a quantum computer; obtaining a parameterized representation of an assertion channel; initializing a set of parameters of the parameterized representation of the assertion channel; determining a difference measure between a first portion of the program circuit and the parameterized representation of the assertion circuit based on the set parameters; modifying the set of parameters based at least in part the difference measure; and determining a sequence of gates performable by the quantum computer that enact the parameterized representation of the assertion channel with a final set of parameters.

According to yet another aspect, a method for improving operation of a quantum computer is provided. The method is performed by at least one classical processor. In an example embodiment, the method includes generating a modified program circuit based on a quantum program circuit to be executed by the quantum computer, one or more groups of check qubits, and one or more placeholders, the one or more groups of check qubits and the one or more placeholders identified in the quantum program circuit; simulating a plurality of iterations of performing the modified program circuit to generate output probability distributions; processing the output probability distributions to identify at least one immediate quantum assertion; implementing the at least one immediate quantum assertion in the quantum program circuit; causing the quantum computer to execute the quantum program circuit with the at least one immediate quantum assertion implemented therein; receiving an output of executing the quantum program circuit; and determining and providing an indication of assertion results based at least in part on the output of executing the quantum program circuit. The indication of the assertion results identifies at least one of (a) at least one qubit having a quantum state of an expected quantum state class at a particular point in the execution of the quantum program circuit by the quantum computer or (b) at least one qubit having a quantum state that is not of the expected quantum state class at the particular point in the execution of the quantum program circuit by the quantum computer.

According to another aspect, a classical computing entity configured for determining an assertion circuit is provided. In an example embodiment, the classical computing entity comprises at least one (semiconductor-based) processor and memory (e.g., at least one non-transitory, semiconductor-based computer storage medium) storing computer-executable instructions. The memory and the computer-executable instructions are configured to, when executed by the at least one processor, cause the classical computing entity to perform generating a modified program circuit based on a quantum program circuit to be executed by the quantum computer, one or more groups of check qubits, and one or more placeholders, the one or more groups of check qubits and the one or more placeholders identified in the quantum program circuit; simulating a plurality of iterations of performing the modified program circuit to generate output probability distributions; processing the output probability distributions to identify at least one immediate quantum assertion; implementing the at least one immediate quantum assertion in the quantum program circuit; causing the quantum computer to execute the quantum program circuit with the at least one immediate quantum assertion implemented therein; receiving an output of executing the quantum program circuit; and determining and providing an indication of assertion results based at least in part on the output of executing the quantum program circuit. The indication of the assertion results identifies at least one of (a) at least one qubit having a quantum state of an expected quantum state class at a particular point in the execution of the quantum program circuit by the quantum computer or (b) at least one qubit having a quantum state that is not of the expected quantum state class at the particular point in the execution of the quantum program circuit by the quantum computer.

According to still another aspect, a computer program product is provided. In an example embodiment, the computer program product comprises at least one non-transitory computer-readable storage medium storing computer-executable instructions. The computer-executable instructions are configured to, when executed by one or more processors of a classical computing entity, cause the classical computing entity to perform generating a modified program circuit based on a quantum program circuit to be executed by the quantum computer, one or more groups of check qubits, and one or more placeholders, the one or more groups of check qubits and the one or more placeholders identified in the quantum program circuit; simulating a plurality of iterations of performing the modified program circuit to generate output probability distributions; processing the output probability distributions to identify at least one immediate quantum assertion; implementing the at least one immediate quantum assertion in the quantum program circuit; causing the quantum computer to execute the quantum program circuit with the at least one immediate quantum assertion implemented therein; receiving an output of executing the quantum program circuit; and determining and providing an indication of assertion results based at least in part on the output of executing the quantum program circuit. The indication of the assertion results identifies at least one of (a) at least one qubit having a quantum state of an expected quantum state class at a particular point in the execution of the quantum program circuit by the quantum computer or (b) at least one qubit having a quantum state that is not of the expected quantum state class at the particular point in the execution of the quantum program circuit by the quantum computer.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is a schematic diagram illustrating an example system, according to an example embodiment.

FIG. 2 is a circuit visualization of three types of immediate quantum assertions, according to an example embodiment.

FIG. 3 is a flowchart illustrating processes, procedures, and/or operations performed by a classical computing entity, for example, to automatically implement immediate quantum assertions in a quantum program circuit and to determine and provide assertion results based thereon, according to an example embodiment.

FIG. 4 is a schematic diagram illustrating determining and/or monitoring a noise status of a quantum computer during operation thereof, according to an example embodiment.

FIG. 5 is a flowchart illustrating process, procedures, and/or operations performed by a controller of a quantum computer, for example, to provide an indication of the noise status of the quantum computer, according to an example embodiment.

FIG. 6 provides a table showing various assertion measurements for different noise levels in a simulated environment, according to an example embodiment.

FIG. 7 is a flowchart illustrating processes, procedures, and/or operations performed by a classical computing entity, for example, to generate an assertion circuit, according to an example embodiment.

FIG. 8 provides a schematic diagram of an example classical computing entity that may be used in accordance with an example embodiment.

### DETAILED DESCRIPTION OF SOME EXAMPLE EMBODIMENTS

The present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally,” “substantially,” and “approximately” refer to within engineering and/or manufacturing tolerances and/or within user measurement capabilities, unless otherwise indicated. Like numbers refer to like elements throughout.

Various embodiments provide methods, systems, apparatus, computer program products, and/or the like determining and/or monitoring a noise status of a quantum computer during performance of a program circuit. For example, performance of the program circuit and/or portion thereof by the quantum computer may be validated based at least in part on the noise status of the quantum computer while the program circuit was performed thereby. Various embodiments use concurrent assertions to monitor and/or determine a noise status of a quantum computer while the quantum computer executes a program circuit.

A quantum circuit is a computational routine consisting of coherent quantum operations on quantum data, such as qubits. In other words, a quantum circuit is an ordered sequence of one or more quantum gates and may further include measurements and/or resets. As used herein a program circuit is a series of one or more quantum circuits that, when executed by a quantum computer, cause the quantum computer to perform a desired quantum computation.

An assertion circuit is a quantum circuit that causes performance of a quantum assertion that provides for monitoring and/or determining the noise status of the quantum computer while the quantum computer is performing at least a first portion of the program circuit. In various embodiments, the first portion of the circuit is a single gate (e.g., a single single-qubit gate or a single two-qubit gate). In various embodiments, the first portion of the circuit includes a plurality of gates (e.g., a plurality of single qubit and/or two-qubit gates performed as one or more sequences of gates that are performed in series and/or in parallel).

As used herein a quantum assertion is a quantum algorithm that consists of a series of quantum gates that will evolve an initial quantum state of a qubit to an arbitrary desired output state. Each quantum gate of the series of quantum gates is reversible, linear, and unitary. At any given moment during performance of a quantum computation, the quantum state of the qubits of a quantum computer is a general superposition (e.g., combination) of all possible states.

Namely, given n-qubits initialized to the system state |0 [symbol] ^{⊗n}, and a quantum circuit [symbol] consisting of m-gates in a sequence

$${\{ {U}_{i} \}}_{i = 1}^{m} ,$$

then the output of [symbol] gives the final state |ψ [symbol] = [symbol] |0 [symbol] ^{⊗n}=(Uₘ∘Uₘ₋₁∘ . . . ∘U₁)|0 [symbol] ^{⊗n}. By adding an assertion [symbol] , which may be a set of assertions {Aᵢ}, to an existing quantum circuit [symbol] that asserts a property of the quantum state |ψᵢ [symbol] at a given point in the quantum circuit, information regarding the property of the quantum state at the given point in the quantum circuit may be determined. For example, to assert the quantum state after the application of the first quantum gate would yield |ψ′ [symbol] =(Uₘ∘Uₘ₋₁∘ . . . ∘ [symbol] ∘U₁)|0 [symbol] ^{⊗n′}. In general, there are infinitely many properties that a quantum state |ψᵢ [symbol] may have since a quantum state is a general superposition consisting of complex-valued amplitudes. Fortunately, certain quantum states, and specific sequences of quantum gates, yield desirable and well-known states such as classical quantum states, superposition states, or entangled states.

A classical quantum state |ψ [symbol] _{C} is a quantum state that is only one basis state, such that up to a global phase θ,

$${\vert ψ 〉}_{C} = {e}^{i θ} {\sum }_{j = 0}^{n - 1} {δ}_{j , k} \vert j 〉 = {e}^{i θ} \vert k 〉 ,$$

where δ_{j,k} is the Kronecker delta function denoting that only the k-th state is active. A superposition state |ψ [symbol] _{S} is a quantum state that includes multiple basis states, such that up to a global phase θ,

$${\vert ψ 〉}_{S} = {e}^{i θ} {\sum }_{j = 0}^{n - 1} {α}_{j} \vert j 〉 ,$$

where |αⱼ|² is the probability of finding a qubit in the j-th state. An entangled state is a quantum state that cannot be written as a combination of individual qubit states. One example of an entangled state |ψ [symbol] _{E} is when, for n-qubits, the state is a combination of two basis states (e.g., |0 [symbol] and |1 [symbol] ), such that up to a global phase θ,

$${{{\vert ψ 〉}_{E} = \frac{{e}^{i θ}}{\sqrt{2}} ( \vert 0 〉}^{⊗ n} + \vert 1 〉}^{⊗ n} ) ,$$

which is generally known as a cat entangled state. When n=2, the cat entangled state is referred to as the Bell state and when n=3, the cat entangled state is referred to as the Greenberger-Horne-Zeilinger (GHZ) state.

Quantum computing is expected to significantly out-perform classical computing on many hard problems due to quantum mechanical effects such as entanglement and superposition. However, quantum computers can be quite noisy. Since qubits rely on the principles of quantum mechanics, they possess an inherent small size and extreme susceptibility to environmental interactions. These interactions have the potential to introduce errors into the qubits or even completely erase the information stored by the qubits.

Conventional techniques for validating the noise status of a quantum computer tend to include the use of immediate assertions. These immediate assertions include performing a quantum circuit with a known result prior to beginning performance of a program circuit to determine whether to obtained result matches the known result. However, these forms of immediate assertions fail to provide insight into the noise status of a quantum computer while the quantum computer is performing a program circuit. Given the noisy nature of current quantum computers, validating the noise status of a quantum computer during the execution of a quantum program by the quantum computer may desired so as validate that the quantum computer was operating as intended during performance of the program circuit. Therefore, technical problems exist regarding monitoring the noise experienced by a quantum computer during performance of a program circuit.

Various embodiments provide technical solutions to these technical problems. For example, various embodiments provide for performance of concurrent assertions. The concurrent assertions are executed by the quantum computer while (e.g., overlapping in time) the quantum computer is performing at least a first portion of a quantum circuit. Thus, the results of the concurrent assertion provide a noise status of the quantum computer while the quantum computer was performing the program circuit.

In various embodiments, performing the concurrent assertion includes performing an assertion circuit concurrently with performance of the program circuit. In various embodiments, the assertion circuit comprises one or more gates that enact a single qubit unitary gate that approximates the performance of the first portion of the quantum circuit. Thus, the assertion circuit only requires one additional qubit (in addition to the system qubits used to perform the program circuit and at least one ancilla qubit) for performance thereof. Thus, the overhead added by including the assertion circuit is low.

Moreover, the noise status determined by performance of the assertion circuit may be used to cease execution of the program circuit when the noise status indicates that the noise levels experienced by the quantum computer are too high, so as to prevent wasting of resources in completing a program circuit shot that will not yield usable results.

Various embodiments provide for the automated performance of immediate quantum assertions. Immediate quantum assertions provide insight as to whether the state of a group of qubits is of an expected class of quantum states at a particular point in a quantum program circuit. Thus, the automated performance of immediate quantum assertions enables the identification of particular points in a quantum program circuit where the quantum state of a group of qubits is not of the expected class of quantum states for that group of qubits at that particular point in the quantum program circuit. This information may be used to identify sources of noise, sources of gate infidelity, and/or other error sources in the operation of the quantum computer such that the error sources may be addressed and mitigated.

Therefore, various embodiments provide technical advantages to the technical fields of quantum computing and noise assessment in quantum computing.

### Example System Architecture

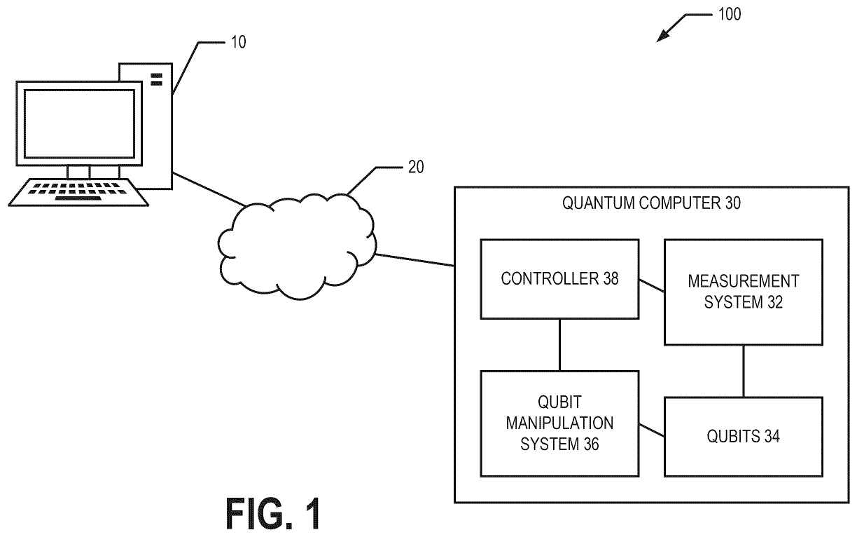

FIG. 1 provides a block diagram of an example system 100 that maybe used in various embodiments. In various embodiments, the system 100 comprises a classical computing entity 10 and a quantum computer 30.

The quantum computer 30 comprises a controller 38, a qubit manipulation system 36, a plurality of qubits 34, and a qubit measurement system 32. In various embodiments, the controller 38 is configured to control operation of the qubit manipulation system 36 and to receive input from the qubit measurement system 32. The qubit manipulation system 36 is configured to perform quantum logic operations and/or gates on the qubits 34. The qubit measurement system 32 is configured to measure the respective quantum states of the qubits 34. The qubit measurement system 32 provides sensor signals and/or an indication of the results of processing sensor signals to the controller 38 that provide an indication of the measured respective quantum states of the qubits 34. For example, the controller 38 may cause the quantum computer 30 to perform one or more quantum circuits by causing the qubit manipulation system 36 to perform a sequence of quantum logic operations indicated by the quantum circuits on the one or more qubits 34.

In various embodiments, the quantum computer 30 is configured to perform quantum logic operations on one or more qubits 34. The quantum computer 30 may then use the qubit measurement system 32 to measure the respective quantum states of one or more of the qubits 34 as a result of the performance of the quantum circuit and/or program by the quantum computer 30.

In various embodiments, the controller 38 comprises one or more classical and/or semiconductor-based processing elements (e.g., processors, programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, graphics processing units (GPUs), central processing units (CPUs), and/or other processing circuitry) and classical and/or semiconductor-based memory (e.g., ROM, PROM, EPROM, EEPROM, flash memory, MMCs, SD memory cards, Memory Sticks, CBRAM, PRAM, FORAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like). The classical and/or semiconductor-based memory stores executable instructions configured, to when executed by the classical and/or semiconductor-based processing elements of the controller 38, cause the controller 38 to control operation of the qubit manipulation system 36 to cause performance of one or more quantum circuits.

In various embodiments, the qubit manipulation system 36 comprises current and/or voltage sources (e.g., digital-to-analog converters (DACs), analog-to-digital converters (ADCs), arbitrary waveform generators (AWGs), and/or the like), lasers, microwave sources, magnetic field sources, and/or other components configured to interact with the qubits 34 and/or generate a signal configured to interact with the qubits 34. In various embodiments, the qubits 34 of a quantum computer may be photons, coherent states of light, electrons, atomic nuclei, optical lattices, Josephson junctions, quantum dots, ions, atoms, non-abelian anyons, vibrational states of a particle, van der Waals heterostructures, and/or other quantum-mechanical systems. In various embodiments, the qubit measurement system 32 comprises one or more components configured to determine a quantum state of one or more of the qubits 34. For example, the qubit measurement system 32 comprises photodetectors (e.g., photodiodes, photomultiplier tubes, charge-coupled device (CCD) photosensors, and/or the like), magnetometers, oscillators, and/or the like, in various embodiments. For example, the qubit manipulation system 36 and the qubit measurement system 32 comprise components configured for manipulating and/or measuring a quantum state, respectively, of the qubits 34 of the quantum computer 30.

In various embodiments, the quantum computer 30 is in communication with a classical computing entity 10 via one or more wired or wireless networks 20 and/or via direct wired and/or wireless communications. For example, the classical computing entity 10 may be configured to provide a quantum circuit to the quantum computer 30 and receive measured values corresponding to the qubit measurements indicating the quantum states of the one or more qubits 34 as a result of the performance of a quantum circuit by the quantum computer 30.

### Example Automated Generation of Quantum Immediate Assertions

Various embodiments enable the automated generation and insertion of quantum immediate assertions within a quantum program circuit. An immediate assertion is an assertion that checks a specific state of a qubit or a set of qubits at a specific point in time during the execution of a quantum program circuit.

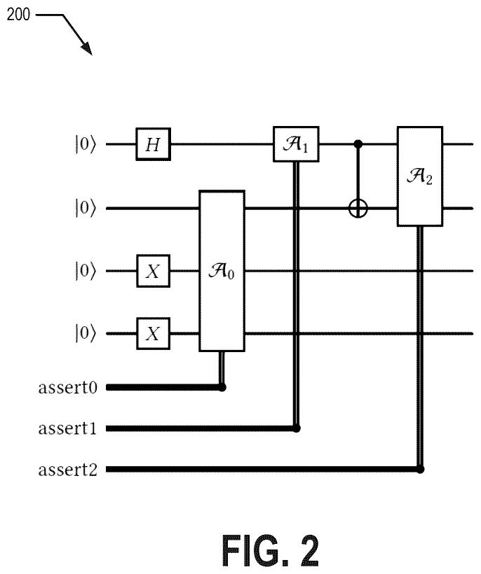

FIG. 2 illustrates an example circuit representation 200 of three classes of immediate assertions—classical, superposition, and entanglement. A classical immediate assertions, such as assert0 shown in FIG. 2, has the capability of checking whether the quantum state of a qubit or set of qubits at a specific breakpoint in a quantum program circuit is a classical quantum state. Classical assertions may be used, in various embodiments, to debug a quantum program circuit to identify whether any errors occurred which have the ability to change a classical state to another state or change an expected classical value to some other classical value. A classical immediate assertion A_{C} is composed of a combinational assertion using propositional logic equivalence, such that A_{C}:assert(input)⇔|output [symbol] ). A classical immediate assertion may be used to check qualities of a quantum program circuit, such as reversibility. An example placement of a classical immediate assertion is shown in FIG. 2 as assert0.

A superposition immediate assertion, such as assert1 shown in FIG. 2, has the capability to check whether the quantum state of a qubit or set of qubits at a specific breakpoint in a quantum program circuit is a superposition state. For example, a uniform superposition immediate assertion has the capability to check whether the quantum state of a qubit or set of qubits at a specific breakpoint in a quantum program circuit is a uniform superposition state (e.g., there is an equal likelihood of the qubit or set of qubits being in any state of available states). Superposition immediate assertions may be used when debugging a quantum program circuit to identify any errors which can change a particular superposition state (e.g., a uniform superposition state) to another state. A superposition immediate assertion A_{S}, such as a uniform superposition immediate assertion, is composed of a combinational assertion using the propositional logic implication, such that A_{S}:assert(|input [symbol] →|ψ_{S} [symbol] ). An example placement of a superposition immediate assertion is shown in FIG. 2 as assert1.

An entanglement immediate assertion has the capability of checking whether the quantum state of a qubit or set of qubits at a specific breakpoint in a quantum program circuit is in a particular entangled state (e.g., a cat entangled state). Entanglement immediate assertions can be used when debugging a quantum program circuit to identify whether any error occurred that changed the particular entangled state (e.g., a cat entangled state) to any other state. An entanglement immediate assertion A_{E}, such as a cat entanglement immediate assertion, is composed of superpositions assertions using the propositional logic implication, such that A_{E}:assert(|input [symbol] →|ψ_{E} [symbol] ). An example placement of an entanglement immediate assertion is shown in FIG. 2 as assert2.

In various embodiments, quantum immediate assertions may be generated and implemented in a quantum program circuit. For example, as part of a debugging process, quantum immediate assertions may be automatically generated and implemented in a quantum program circuit. The assertion results provided as a result of implementing the quantum immediate assertions may be provided such that the quantum program circuit may be debugged and/or any errors identified may be addressed. For example, based on the assertion results, one or more parameters and/or aspects of a qubit manipulation system 36 may be updated, modified, and/or the like.

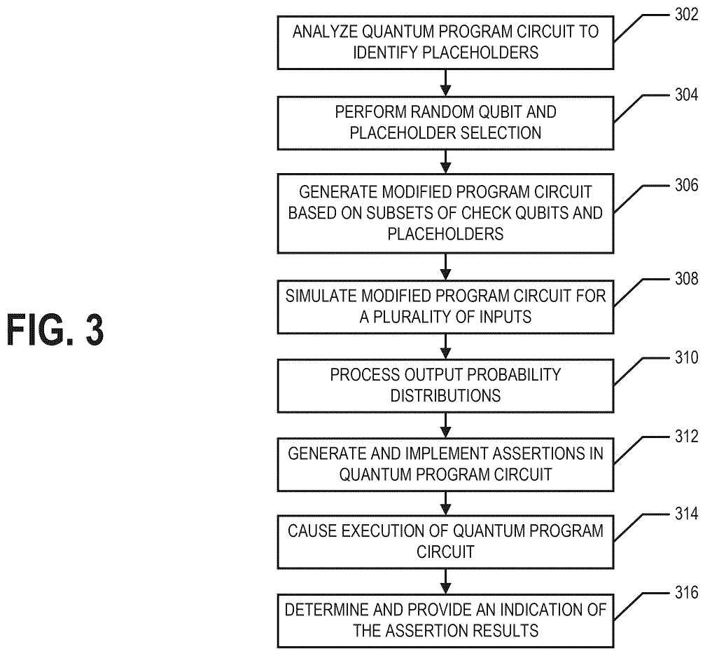

FIG. 3 provides a flowchart illustrating various processes, procedures, and/or the like performed by a classical computing entity 10, in various embodiments, to generate and implement immediate quantum assertions and to use the assertion results thereof to improve the performance of the quantum computer 30. Starting at step 302, the classical computing entity 10 analyzes the quantum program circuit to identify placeholders. For example, the classical computing entity 10 statically analyzes the quantum program circuit and identifies placeholders or candidate placements of assertions and measurements within the quantum program circuit. In various embodiments, the static analysis of the quantum program circuit is configured to identify common functionalities such as include of Hadamard gates, controlled not (CNOT) gates, X gates, etc. By uncovering the common functionalities, the classical computing entity 10 identifies check qubits. The check qubits are qubits of the quantum program circuit that, based on the static analysis of the quantum program circuit, the classical computing entity 10 determines as candidate qubits to check via an immediate quantum assertion.

At step 304, the classical computing entity 10 randomly selects a subset of the check qubits and randomly selects a subset of the placeholders. In various embodiments, the subset of check qubits includes a range of one check qubit to all of the check qubits. In various embodiments, the subset of placeholders includes a range of one placeholder to all of the placeholders. In various embodiments, the subset of check qubits and the subset of placeholders are selected in accordance with one another. For example, a first group of check qubits (comprising one, two, or three check qubits) of the subset of check qubits is associated with a first placeholder of the subset of placeholders such that that the first placeholder, an assertion is performed on the first group of check qubits.

At step 306, the classical computing entity 10 generates a modified program circuit based at least in part on the subset of check qubits and the subset of placeholders. For example, the modified program circuit may be generated based on the subset of check qubits, the subset of placeholders, and the quantum program circuit. In an example embodiment, generating the modified program circuit includes inserting and/or adding measurement points for the check qubits of the subset of check qubits at the associated placeholders of the subset of placeholders. For example, continuing the example from above, measurement points for the first group of check qubits is inserted and/or added at the first placeholder.

At step 308, the classical computing entity 10 simulates or causes simulation (e.g., by another classical computing entity or group of classical computing entities) of the modified program circuit using a plurality of inputs. For example, the modified program circuit may be simulated a plurality of times with different input. In certain embodiments, for each iteration of simulating the modified program circuit, a random input is generated and used to perform the simulation. When simulating the modified program circuit, the simulation collapses the quantum state of each group of check qubits to a classical state at the associated measurement points (e.g., at the associated placeholders). The probability distribution of the outputs (e.g., the classical states) are stored in the execution trace.

At step 310, after the simulation is completed for each placeholder for a plurality of iterations, the classical computing entity 10 processes the output probability distributions to identify quantum assertions. For example, the classical computing entity 10 analyzes the execution trace to mine the assertions therefrom. In various embodiments, assertions of a plurality of classes are identified.

In an example embodiment, chi-squared testing is used to analyze the probability distributions in the execution trace. A chi-squared test is a statistical hypothesis test that is used to identify significant differences between expected frequencies with observed frequencies. For example, a chi-squared test may be used to determine whether an output probability distribution corresponds to one of a selected set of classes of states. For example, the set of classes of states include classical quantum states, uniform superposition states, and the Bell state, in an example embodiment. The results are used to determine and/or generate a plurality of classes of assertions. In an example embodiment, a class of assertions corresponding to each class of states is determined and/or generated.

In an example embodiment, a classical quantum assertion is determined and/or generated. To determine and/or generate a classical quantum assertion, the hypothesis of the chi-squared test is selected such that the expected distribution should be unimodal distribution with one peak value. For example, the expected distribution is compared with the observed probability distributions of the execution trace to determine a p-value of the test. When the p-value is less than a threshold value (e.g., 0.05), the observed distribution is not unimodal and the null hypothesis is rejected. When the p-value is greater than the threshold value, the observed distribution is unimodal and the null hypothesis is accepted, indicating that an assertion performed at the corresponding placeholder on the associated group of check qubits yields a classical quantum assertion.

In an example embodiment, a uniform superposition assertion is determined and/or generated. To determine and/or generate a uniform superposition assertion, the hypothesis of the chi-squared test is selected such that the expected distribution should a uniform distribution. For example, a uniform probability value of ½ₙ, where n is the number of check qubits in the group of check qubits, is selected. For example, when the group of check qubits includes two qubits, there are four possible output states (e.g., |00 [symbol] , |01 [symbol] , |10 [symbol] , and |11 [symbol] ) and the probability of each state is approximately one-fourth. For example, the expected distribution is compared with the observed probability distributions of the execution trace to determine a p-value of the test. When the p-value is less than a threshold value (e.g., 0.05), the observed distribution is not uniform and the null hypothesis is rejected. When the p-value is greater than the threshold value, the observed distribution is uniform and the null hypothesis is accepted, indicating that an assertion performed at the corresponding placeholder on the associated group of check qubits yields a uniform superposition quantum assertion.

In an example embodiment, a cat entangled state assertion is determined and/or generated. To determine and/or generate a cat entangled state assertion, the hypothesis of the chi-squared test is selected in accordance with Table 1. In other words, the two-qubit cat entangled state, known as the Bell state, corresponds to a probability of 0.5 of the group of check qubits (consisting of two qubits) being in the state |00 [symbol] , a probability of 0.5 of the group of check qubits being in the state |11 [symbol] , and a probability of 0.0 of the group of check qubits being in the states |01 [symbol] and |10 [symbol] . the expected distribution is compared with the observed probability distributions of the execution trace to determine a p-value of the test. When the p-value is less than a threshold value (e.g., 0.05), the observed distribution does not correspond to the Bell state and the null hypothesis is rejected. When the p-value is greater than the threshold value, the observed distribution is determined to correspond to the Bell state and the null hypothesis is accepted, indicating that an assertion performed at the corresponding placeholder on the associated group of check qubits yields a cat entangled state quantum assertion.

TABLE 1

SECOND QUBIT

| | | |
|---|---|---|
| PROBABILITY | 0 | 1 |

| | | | |
|---|---|---|---|
| FIRST | 0 | 0.5 | 0.0 |
| QUBIT | 1 | 0.0 | 0.5 |

At step 312, the classical computing entity 10 generates and implements quantum assertions in the quantum program circuit. In an example embodiment, generating and implementing the quantum assertions in the quantum program circuit includes randomly sampling and/or selection a subset of the assertions identified at step 310 and the selected assertions are implemented in the quantum program circuit.

In various embodiments, implementing a selected assertion includes adding and/or inserting a measurement operation into the quantum program circuit to be performed on the check qubits associated with the selected assertion at the placeholder associated with the selected assertion. These measurement operations may be performed in a variety of ways. One example is an encoded measurement operation. An encoded measurement operation may include encoding the quantum state of one or more check qubits (e.g., a group of check qubits) onto one or more ancilla qubits such that the measurement does not collapse the quantum states of the check qubits themselves. Another example is a direct measurement operation. A direct measurement operation includes directly measuring the quantum state of one or more check qubits (e.g., the group of check qubits). Directly measuring the quantum state of the one or more check qubits causes the quantum state of the one or more check qubits to collapse to corresponding classical quantum states. In some embodiments, after performing a direct measurement operation either performance of the quantum program circuit is stopped or the results of the quantum program circuit are discarded. Another example is a projection measurement operation. a projection measurement operation includes determining and/or identifying whether the quantum state is in a specified subspace of the total state space without causing collapse of the quantum state.

In some embodiments, the measurement operation performed is dependent on the class of the assertion. For example, in certain embodiments, when the quantum assertion being implemented is a classical quantum assertion, the measurement operation inserted and/or added to the quantum program circuit may be a direct measurement of the quantum states of the one or more check qubits associated with the assertion. In particular, if the one or more check qubits associated with the assertion are expected to be in classical quantum states, causing the quantum states to collapse does not obstruct the remaining computation.

In certain embodiments, when the quantum assertion being implemented is a cat entangled state assertion, the measurement operation inserted and/or added into the quantum program circuit includes using a projection measurement that identifies if the quantum state is in a specified subspace of the total state space. For example, in such scenarios, the entangled state belongs to the stabilizer subspace which is determined by the stabilizer subgroup. The stabilizer subgroup is generated by at most n Pauli operators, resulting in a linear scaling of implementation of the measurement operation.

At step 314, the classical computing entity 10 causes execution of the quantum program circuit. In various embodiments, the quantum program circuit may be executed a plurality of times (e.g., for a plurality of shots). In certain embodiments, the classical computing entity 10 provides the quantum program circuit having the assertions inserted and/or added therein to a quantum computer 30 (e.g., to the controller 38 of the quantum computer 30). The controller 38 then controls operation of the qubit manipulation system 36 based on the quantum program circuit to cause a controlled evolution of the quantum states of the qubits 34 in accordance with the quantum program circuit.

In various embodiments, the quantum computer 30 provides the classical computing entity 10 with measurement results obtained during the performance of the quantum program circuit. In some embodiments, the quantum computer 30 provides the classical computing entity 10 with assertion results based on measurement results obtained during the performance of the quantum program circuit. For example, for a particular assertion, one or more measurement operations are performed during the performance of the quantum program circuit (e.g., via the qubit measurement system 32) and the measurement results yield the quantum states of the measured qubits. The quantum states of the measured qubits may be compared to the corresponding class of states of the particular assertion to determine whether the particular assertion is True (e.g., the quantum states of the measured qubits correspond to the class of states of the particular assertion) or False (e.g., the quantum states of the measured qubits do not correspond to the class of states of the particular assertion). The assertion result for the particular assertion is either True or False.

At step 316, the classical computing entity 10 processes received measurements results to determine assertion results, in the scenario that the quantum computer provides the measurement results to the classical computing entity 10. The classical computing entity 10 may process the assertion results (received from the quantum computer 30 or determined based on measurement results received from the quantum computer 30). The classical computing entity 10 may provide an indication of the assertion results. For example, the classical computing entity 10 may provide an indication of the assertion results that identifies the group of check qubits and/or placeholder associated with an assertion result of False. In some embodiments, the indication of the assertion results identifies groups of check qubits and/or placeholders associated with assertion results of True.

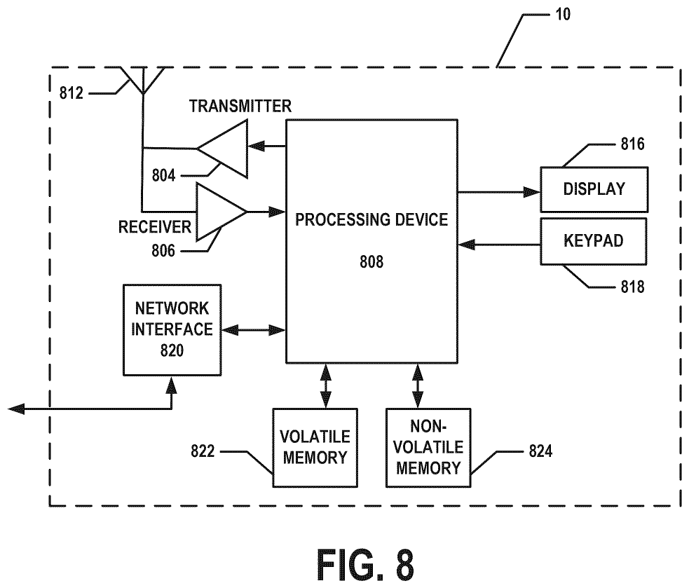

For example, the indication of the assertion results may be displayed via a user interface (e.g., display 816, see FIG. 8) of the classical computing entity 10, stored in (semiconductor-based) memory 822, 824 of the classical computing entity 10, used as input to one or more programs and/or algorithms operating on the classical computing entity 10, and/or the like.

In various embodiments, the quantum program circuit, one or more parameters or aspects of the qubit manipulation system 36, and/or another parameter or aspect of the quantum computer 30 may be modified and/or updated based on the indication of the assertion results. For example, one or more sources of noise, causes of gate infidelity, and/or the like may be identified based at least in part on the indication of the assertion results. The operation of the quantum computer 30 may then be updated and/or modified to mitigate the source of noise, mitigate the cause of the gate infidelity, and/or the like.

Example Monitoring and/or Determining of a Noise Status of a Quantum Computer Using Concurrent Assertions

Various embodiments provide for monitoring and/or determining a noise status of a quantum computer using concurrent assertions. For example, the noise status of the quantum computer indicates the noise level experienced by a quantum computer during performance of at least a first portion of a program circuit and/or whether the noise level experienced by the quantum computer during performance of at least a first portion of a program circuit satisfies a confidence threshold requirement.

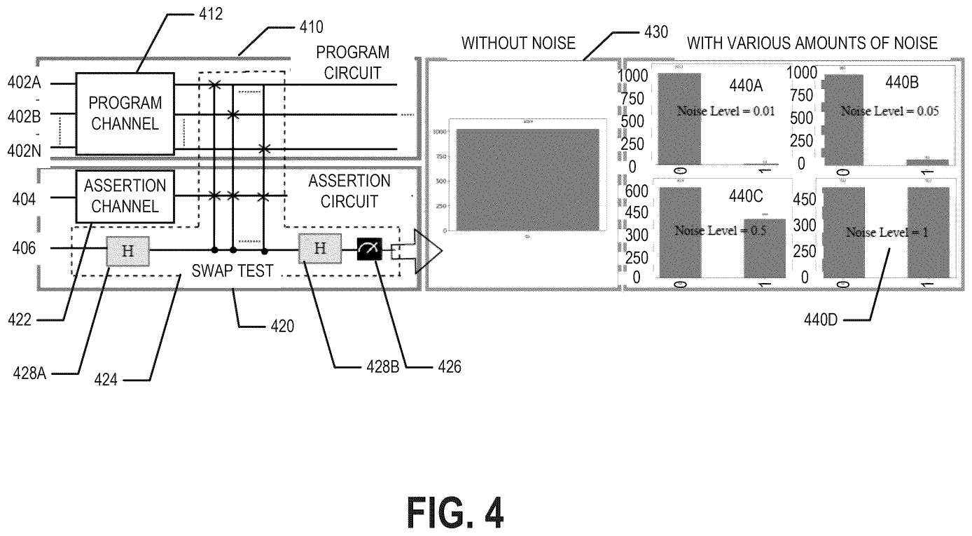

FIG. 4 provides a schematic diagram of determining and/or monitoring a noise status of a computer program during performance of at least a first portion of a program circuit 410. The program circuit 410 is performed on a plurality of system qubits 402 (e.g., 402A, 402B, . . . , 402N) of the plurality of qubits 34. The program circuit 410 includes a first portion of the program circuit which is a program channel 412.

A quantum channel C, such as the program channel 412 and/or the assertion channel 42422, is a mapping defined as C:H(ρ)→H′(ρ′), where H is a first Hilbert space of dimension N and the channel C maps the density of states p in the first Hilbert space H to the density of states ρ′ in a second Hilbert space H′ of dimension M. The first Hilbert space H and the second Hilbert space H′ may be the same or different Hilbert spaces. The channel C maintains the properties of complete positivity and trace preservation. An example of a quantum channel is a unitary operator U, which enables coherent evolution of quantum states of qubits, and which may be expressed as ρ′=UρU^{†}.

The assertion circuit 420 includes an assertion channel 42422 and a comparison test 424, such as a SWAP test. The assertion channel 42422 is performed on an assertion qubit 404 of the plurality of qubits 34. The assertion channel 42422 is configured to approximate the performance of the first portion of the program circuit (e.g., program channel 412) using a single qubit (e.g., the assertion qubit 404). For example, the assertion channel 42422 is a single qubit unitary gate that approximates the performance of the program channel 412, in an example embodiment.

In various embodiments, the program channel 412 is a sequence of single and/or multi-qubit unitary gates determined based on the desired quantum computation to be performed via the program circuit 410. In various embodiments, the assertion channel 42422 is performed by a quantum computer concurrently with performance of the program channel 412.

The comparison test 424 compares the quantum state of the assertion qubit 404 as a result of performance of the assertion channel 42422 to the quantum states of the system qubits 402 as a result of performance of the program channel 412. In the illustrated embodiment, the comparison test 424 is a SWAP test. For example, the SWAP test of the illustrated embodiment includes a first Hadamard gate 428A performed on an ancilla qubit 406 starting in an initialized state. A sequence of controlled SWAP gates is then performed on the assertion qubit 404 and the system qubits 402 using the ancilla qubit 406. A second Hadamard gate 428B is then performed on the ancilla qubit 406 prior to a measurement 426 being performed on the ancilla qubit 406. For example, when the assertion qubit 404 is in state |φ [symbol] , the system qubits are in state |ψ [symbol] , and the ancilla qubit is initialized into state |0 [symbol] prior to performance of the first Hadamard gate 428A, the initial system state (e.g., before performance of the first Hadamard gate 428A and after performance of the assertion channel 42422 and the program channel 412) is |Ψ [symbol] =|0 [symbol] |φ [symbol] |ψ [symbol] . After performance of the second Hadamard gate 428B on the ancilla qubit 406, the system state is

$$\vert {Ψ}^{′} 〉 = \frac{1}{2} \vert 0 〉 ( \vert ϕ 〉 \vert ψ 〉 + \vert ψ 〉 \vert ϕ 〉 ) + \frac{1}{2} \vert 1 〉 ( \vert ϕ 〉 \vert ψ 〉 - \vert ψ 〉 \vert ϕ 〉 ) .$$

Therefore, the probability of measurement 426 yielding the measurement result that the quantum state of the ancilla qubit is |0 [symbol] is given as

$$\frac{1}{2} + \frac{1}{2} {\vert 〈 ψ \vert ϕ 〉 \vert}^{2} .$$

When the quantum state of the assertion qubit 404 |φ [symbol] is the same as the quantum state of the system qubits 402 |ψ [symbol] , the probability of the measurement 426 yielding the measurement result that the quantum state of the ancilla qubit is in quantum state |0 [symbol] is 1 (e.g., 100%). Therefore, for an appropriately generated and/or determined assertion channel 42422, when no noise is experienced by the quantum computer 30 during performance of the program channel 412 and the assertion channel 42422, the measurement 426 should always yield a measurement result that the ancilla qubit 406 is in quantum state |0 [symbol] , as shown by histogram 430.

If noise is experienced by the quantum computer 30 during performance of the program channel 412 and the assertion channel 42422, even when the assertion channel 42422 is appropriately generated and/or determined, the probably of the measurement 426 yielding the measurement result that the quantum state of the ancilla qubit is in quantum state |0 [symbol] is less than 1. Moreover, the likelihood that the measurement 426 yields the measurement result that the quantum state of the ancilla qubit is in quantum state |0 [symbol] reduces as the noise level experienced by the quantum computer 30 during performance of the program channel 412 and the assertion channel 42422 increases. For example, as shown by histograms 440A and 440B, when the noise level is low (e.g., 0.01 and 0.05, respectively) the likelihood that measurement 426 yields the measurement result that the quantum state of the ancilla qubit is in quantum state |0 [symbol] is still close to one and the likelihood that measurement 426 yields the measurement result that the quantum state of the ancilla qubit is in quantum state |1 [symbol] is close to zero. However, as shown by histogram 440C, when the noise level reaches 0.5, the distribution of measurement results determined based on the measurement 426 is clearly bimodal. As shown by histogram 440D, when the noise level reaches 1.0, the distribution of measurement results determined based on the measurement 426 approximately 50% |0 [symbol] and approximately 50% |1 [symbol] . In other words, | [symbol] ψ|φ [symbol] |²≈0 and the noise level experienced by the quantum computer 30 during performance of the program channel 412 and the assertion channel 42422 was significant enough to scramble and/or destroy the quantum information stored by the assertion qubit 404 and the system qubits 402.

In various embodiments, assertion circuits corresponding to a first portion, second portion, third portion, . . . , Nth portion of a program circuit may be performance as the quantum computer performs the program circuit. In this manner, the noise level experienced by the quantum computer 30 throughout the performance of the program circuit and/or the evolution of the noise level experienced by the quantum computer 30 during the performance of the program circuit may be monitored and/or determined.

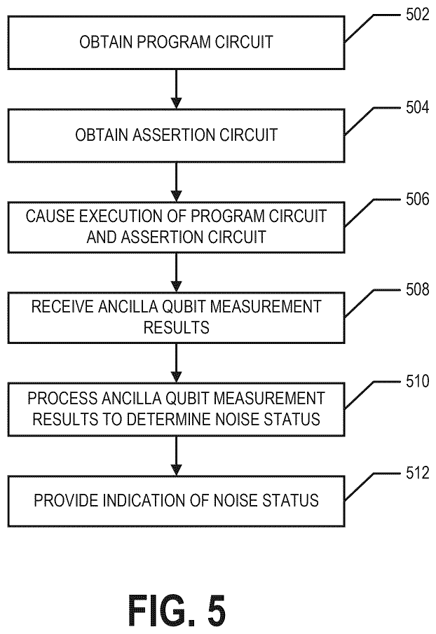

FIG. 5 provides a flowchart of process, procedures, operations, and/or the like performed by, for example, the controller 38 of the quantum computer 30 to monitor and/or determine a noise status of the quantum computer 30 corresponding to performance of a program circuit 410 (and/or at least a first portion thereof, such as the program channel 412).

Starting at step 502, the controller 38 obtains a program circuit. In various embodiments, the controller 38 of the quantum computer 30 obtains a program circuit. In various embodiments, the program circuit is received from the classical computing entity 10, accessed from a classical and/or semiconductor-based memory of the controller 38, determined and/or generated by a classical and/or semiconductor-based processing element of the controller 38 (e.g., via execution of executable instructions stored in the classical and/or semiconductor-based memory of the controller 38), and/or the like. In various embodiments, performance of the program circuit by the quantum computer 30 is configured to cause the quantum computer 30 to perform a quantum computation.

At step 504, the controller 38 obtains an assertion circuit corresponding to a first portion of the program circuit. In various embodiments, the assertion circuit corresponding to the first portion of the program circuit is received from the classical computing entity 10, accessed from a classical and/or semiconductor-based memory of the controller 38, determined and/or generated by a classical and/or semiconductor-based processing element of the controller 38 (e.g., via execution of executable instructions stored in the classical and/or semiconductor-based memory of the controller 38), and/or the like.

At step 506, the controller 38 causes the quantum computer 30 to perform the program circuit 410 and the assertion circuit 420. For example, the controller 38 causes the quantum computer to perform the assertion circuit 420 corresponding to the first portion of the quantum circuit and the first portion of the program circuit 410 concurrently. For example, the program channel 412, which is the first portion of the program circuit 410, may be performed concurrently and/or at least partially overlapping in time with the assertion channel 42422 of the assertion circuit 420 corresponding to the first portion of the program circuit 410. Performance of the assertion circuit results in the comparison test 424 (e.g., a SWAP test in an example embodiment) and a measurement 426 of an ancilla qubit 406 used as a control, for example, in the comparison test 424 is captured. In various embodiments, a series of measurements 426 of the ancilla qubit 406 are captured to enable a statistical analysis of the measurement results.

At step 508, the controller 38 receives the ancilla qubit measurement results generated by the measurement 426 of the ancilla qubit 406. For example, the controller 38 is in communication with the qubit measurement system 32 such that the controller 38 may receive one or more sensor signals from the qubit measurement system 32 indicating results of the measurement 426 of the ancilla qubit 406.

At step 510, the controller 38 processes the ancilla qubit measurement results to determine a noise status of the quantum computer 30 during the performance of the first portion of the program circuit 410 and the assertion circuit 420. For example, in an example embodiment, the controller 38 may perform a statistical analysis of the ancilla qubit measurement results to determine whether the distribution of ancilla qubit measurements is unimodal or bi-modal.

In an example embodiment, the controller 38 performs a chi-squared test based on the expectation that the distribution of ancilla qubit measurements should be unimodal is performed. For example, in such an example embodiment, when the p-value of the chi-squared test is less than a p value threshold (e.g., 0.05, in an example embodiment) it is determined that the distribution of ancilla qubit measurements is bi-modal and, when the p-value of the chi-squared test is greater than the p value threshold (e.g., 0.05, in an example embodiment) it is determined that the distribution of ancilla qubit measurements is unimodal. When the distribution of ancilla qubit measurements is bi-modal, a significant amount of noise was experienced by the quantum computer 30 during the performance of the first portion of the program circuit 410 and the assertion circuit 420. When the distribution of ancilla qubit measurements is unimodal, a smaller amount of noise was experienced by the quantum computer 30 during the performance of the first portion of the program circuit 410 and the assertion circuit 420.

In an example embodiment, when the controller 38 determines that the distribution of ancilla qubit measurements is unimodal, the controller 38 determines that the noise status of the quantum computer 30 during the performance of the first portion of the program circuit 410 and the assertion circuit 420 is “acceptable.” In an example embodiment, when the controller 38 determines that the distribution of ancilla qubit measurements is bi-modal, the controller 38 determines that the noise status of the quantum computer 30 during the performance of the first portion of the program circuit 410 and the assertion circuit 420 is “unacceptable.”

In an example embodiment, when the controller 38 determines that the distribution of ancilla qubit measurements is bi-modal, the controller 38 determines a confidence level of assertion. In an example embodiment, the confidence level of the assertion is determined as

$$\frac{1}{N} {\sum }_{i = 1}^{N} SWAP ( E ( {ρ}_{i} ) , F ( {ρ}_{i} ) ) ,$$

412, F(ρᵢ) is the result of performing the assertion channel 42422, and SWAP(E(ρᵢ),F(ρᵢ)) is the result of the SWAP test on the i-th pair of states, and N is the total number of prepared input states. For example, the confidence level indicates how likely the result of the performance of the first portion of the program circuit is accurate (e.g., not substantially effected by noise). In an example embodiment, the noise status of the quantum computer 30 during the performance of the first portion of the program circuit 410 and the assertion circuit 420 is the determined confidence level.

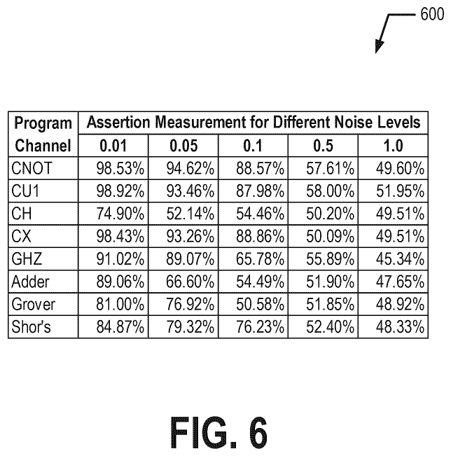

In an example embodiment, a mapping between confidence level and noise level for the quantum computer 30 is known (e.g., stored in a classical and/or semiconductor-based memory of the controller). In such an embodiment, a noise level experienced by the quantum computer 30 during the performance of the first portion of the program circuit 410 and the assertion circuit 420 is the determined based on the confidence level and the mapping. For example, FIG. 6 provides a table 600 that provides a mapping between assertion measurements (e.g., the percentage of times the ancilla qubit quantum state was determined to be the state |0 [symbol] ) and the experienced noise level for a variety of example program channels (e.g., a controlled not gate (CNOT), controlled U1 gate (CU1), controlled Hadamard gate (CH), controlled-X gate (CX), Greenberger-Horne-Zeilinger gate (GHZ), an Adder algorithm, Grover's algorithm, and Shore's Algorithm). In an example embodiment, a table similar to table 600 may be used as a look up table to determine the noise level experienced by the quantum computer based on the ancilla qubit measurement results and/or distribution thereof. For example, in an example embodiment, the noise status of the quantum computer 30 during the performance of the first portion of the program circuit 410 and the assertion circuit 420 is the determined noise level.

In an example embodiment, a confidence threshold requirement is defined. For example, when the determined confidence level is greater than or equal to a predetermined and/or set confidence threshold, the confidence threshold requirement is satisfied and when the determined confidence level is less than the predetermined and/or set confidence threshold, the confidence threshold requirement is not satisfied. In various embodiments, the predetermined and/or set confidence threshold is predetermined and/or set based on the fidelity at which the quantum computer 30 is capable of being operated, a user preference, the quantum computation to be performed, and/or the like. In an example embodiment, the noise status of the quantum computer 30 during the performance of the first portion of the program circuit 410 and the assertion circuit 420 is an indication of whether or not the confidence threshold requirement was satisfied.

In an example embodiment, the noise status of the quantum computer 30 during the performance of the first portion of the program circuit 410 and the assertion circuit 420 is determined in real time with the performance of the program circuit. For example, the controller 38 may process and/or analyze the distribution of ancilla qubit measurements upon receipt of the measurement results. In an example embodiment, the noise status of the quantum computer 30 during the performance of the first portion of the program circuit 410 and the assertion circuit 420 is determined as a post processing step after completion of the program circuit. For example, the controller 38 may wait until the quantum computer 30 finishes performing the program circuit before determining the noise status.

In various embodiments, the controller 38 processes the ancilla qubit measurement results to determine a noise status of the quantum computer 30 during the performance of the first portion of the program circuit 410 and the assertion circuit 420. In an example embodiment, the controller 38 provides (e.g., transmits) the ancilla qubit measurement results for receipt by the classical computing entity 10. The classical computing entity 10 receives the ancilla qubit measurement results and processes the ancilla qubit measurement results to determine a noise status of the quantum computer 30 during the performance of the first portion of the program circuit 410 and the assertion circuit 420. In such an embodiment, the classical computing entity 10 may then provide the indication of the noise status at step 512.

At step 512, the controller 38 provides an indication of the noise status of the quantum computer 30 during the performance of the first portion of the program circuit 410 and the assertion circuit 420. In various embodiments, providing the noise status includes transmitting a noise status message for receipt by a classical computing entity 10. For example, the noise status message may be configured to cause the classical computing entity 10 to display the noise status and/or indication thereof via a user interface (e.g., display 816, see FIG. 8), store the noise status in memory 822, 824 (e.g., in association with information and/or metadata corresponding to performance of the quantum circuit by the quantum computer 30), use the noise status as input to one or more programs and/or algorithms operating on the classical computing entity 10, and/or the like.

In various embodiments, providing the noise status includes storing the noise status in a classical (e.g., semiconductor-based) memory of the controller 38 in association with information and/or metadata corresponding to performance of the program circuit by the quantum computer 30.

In various embodiments, providing the noise status includes causing display of the noise status and/or a noise status indicator (e.g., a green light for an acceptable level of noise, a red light for an unacceptable level of noise, and/or the like) via a user interface associated with and/or in communication with the controller 38.

In various embodiments, providing the noise status includes continuing to cause performance of the program circuit when the noise status satisfies a confidence threshold requirement and/or causing performance of the program circuit to be interrupted and/or stopped when the noise status does not satisfy the confidence threshold requirement. For example, in an example embodiment, the controller 38 is configured to stop and/or cease performing the program circuit when the noise status (e.g., a determined confidence level) does not satisfy the confidence threshold requirement and/or when the noise status is an indication that the determined confidence level does not satisfy the confidence threshold requirement. For example, in an example embodiment, the controller 38 is configured to continue performing the program circuit when the noise status (e.g., a determined confidence level) does satisfy the confidence threshold requirement and/or when the noise status is an indication that the determined confidence level does satisfy the confidence threshold requirement.

### Example Generation of an Assertion Circuit

As noted above, the assertion channel 42422 is configured to approximate the performance of the first portion of the program circuit (e.g., the program channel 412). In various embodiments, the assertion channel is determined using a machine learning process. For example, a parameterized representation of the assertion channel is determined and the set of parameters of the parameterized representation of the assertion channel are determined using a machine learning process, in an example embodiment. A sequence of quantum logic gates that are native to the architecture of the quantum computer 30 that enact the parameterized representation of the assertion channel with the determined and/or learned set of parameters (e.g., a final set of parameters OF) are determined to generate a portion of the assertion circuit 420 that enacts the assertion channel 42422 on an assertion qubit 404.

In various embodiments, the assertion circuit 420 may be formed by concatenating and/or adding a comparison test 424 (e.g., a SWAP test and/or the like) to the assertion channel 42422. In various embodiments, the assertion circuit 420 is determined by the classical computing entity 10 and then provided (e.g., transmitted) to the controller 38 of the quantum computer 30 for storage and/or execution. In various embodiments, the assertion circuit is determined by the controller 38 of the quantum computer 30.

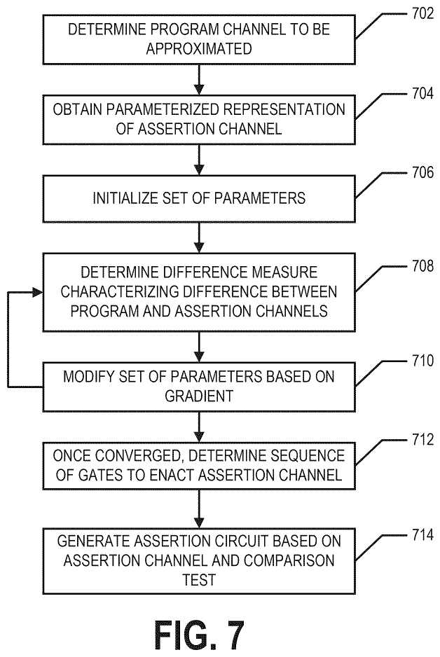

FIG. 7 provides a flowchart illustrating various processes, procedures, operations, and/or the like performed by a classical computing entity 10, for example, generate an assertion circuit 420 corresponding to a first portion of a program circuit 410 (e.g., a program channel 412). For example, the memory 822, 824 of the classical computing entity 10 may store computer-executable instructions configured to, when executed by the processing device 808, causes the classical computing entity 10 to generate an assertion circuit corresponding to a first portion of a program circuit.

Starting at step 702, the classical computing entity 10 determines a program channel to be approximated. For example, the classical computing entity 10 may determine and/or select a first portion of the program circuit to be considered as the program channel. In various embodiments, the first portion of the program circuit is determined and/or selected based on user input (e.g., received via a user input device) and/or based on program channel determination algorithm.

At step 704, the classical computing entity 10 obtains a parameterized representation of the assertion channel. For example, the classical computing entity 10 may receive a parameterized representation of the assertion channel via a user interface device. In another example, the classical computing entity 10 may receive a parameterized representation of the assertion channel via a network interface 820 (e.g., provided and/or transmitted by another classical computing entity). In another example, the classical computing entity 10 may access a parameterized representation of the assertion channel from memory 822, 824.

For example, in various embodiments, the assertion channel is given as F(θ), where θ is a set of tunable parameters.

At step 706, the classical computing entity 10 initializes the set of parameters θ. For example, the classical computing entity 10 may randomly assign values to each parameter of the set of parameters θ within a respective parameter range defined for each parameter. For example, the classical computing entity 10 initializes the set of parameters θ to provide an initial set of parameters θ₀.

At step 708, the classical computing entity 10 determines a difference measure characterizing the difference between the program channel and the parametrized representation of the assertion channel based on the initial set of parameters θ₀. In various embodiments, the distance measure characterizes and/or quantifies how well the parameterized representation of the assertion channel approximates the program channel.

In various embodiments, the difference measure is the diamond norm difference between the program channel (e.g., the first portion of the program circuit) and the assertion channel as given by the parameterized representation of the assertion channel and the current set of parameters. For example, in various embodiments, the difference measure is the diamond norm difference given by ∥E−F(θ)|_{⋄}=sup_{ρ}∥(E⊗I)(ρ)−F(θ)⊗I)(ρ)∥₁, where sup is the supremum taken over all input states ρ that can be operated on by the program channel E and the assertion channel F, I is an operator for the identify map on an ancillary system, and ∥.∥₁ denotes the trace norm. The diamond norm difference thereby measures the worst-case effect of the difference between program channel and the assertion channel.

At step 710, the classical computing entity 10 modifies the set of parameters θ based at least in part on the difference measure. In various embodiments, the set of parameters θ are modified and/or updated based at least in part on a gradient of the difference measure with respect to the set of parameters θ.

For example, in various embodiments, the difference measure is the diamond norm difference between the program channel (e.g., the first portion of the program circuit) and the assertion channel as given by the parameterized representation of the assertion channel and the current set of parameters. In such an embodiment, the set of parameters is modified based at least in part on the gradient of the diamond norm difference between the program channel and the assertion channel with respect to the set of parameters, denoted as ∇_{θ}∥E−F(θ)∥_{⋄}. In general, a gradient of a function with respect to a set of parameters of the function indicates the direction of steepest increase of the function. Therefore, moving in the opposite direction is expected to reduce the value of the function. For example, in an example embodiment, the set of parameters are modified such that θ_{new}=θ_{old}−η∇_{θ}∥E−F(θ)∥_{⋄}, where θ_{new} is the modified set of parameters, θ_{old} is the previous set of parameters, and n is the learning rate, which determines the step size of each iteration of the assertion channel learning process.

In various embodiments, steps 708 and 710 are iterated until convergence criteria are satisfied. For example, in an example embodiment, the convergence criteria are satisfied when the difference measure is less than a threshold difference ϵ. For example, in an example embodiment, the convergence criteria are satisfied when the diamond norm difference between the program channel and the assertion channel is less than the threshold difference |E−F(θ)∥_{⋄}<ϵ. In an example embodiment, the convergence criteria are satisfied when the modified set of parameters θᵢ₊₁ determined at iteration i differs from the previous set of parameters θᵢ. For example, in an example embodiment, the convergence criteria are satisfied when the difference between the modified set of parameters and the previous set of parameters is less than a threshold difference δ such that |θᵢ₊₁−θᵢ∥²<δ. In an example embodiment, the convergence criteria are satisfied when a set maximum number of iterations iₘₐₓ have been performed. For example, the convergence criteria are determined have been satisfied when i=iₘₐₓ. Various convergence criteria may be used in various embodiments.

The set of parameters θ when the classical computing entity 10 determines that the convergence criteria have been satisfied are determined to be the final set of parameters θ_{F}.

At step 712, once the convergence criteria have been satisfied, the classical computing entity 10 determines a sequence of gates that enact the parameterized representation of the assertion channel with the final set of parameters θ_{F}. For example, a sequence of quantum logic gates that are native to the architecture of the quantum computer 30 are determined that, when performed in sequence on an assertion qubit 404, enact the 4 unitary operation indicated by the parameterized representation of the assertion channel with final set of parameters θ_{F}.

At step 714, the classical computing entity 10 generates the assertion circuit 420. In various embodiments, the assertion circuit 420 includes the sequence of gates that enact the unitary operator that is the assertion channel 42422 (e.g., that was determined at step 712) and a comparison test (e.g., a SWAP test and/or the like). For example, the assertion circuit 420 is generated by concatenating the comparison test to the sequence of gates that enact the assertion channel 42422.

In various embodiments, after generating the assertion circuit 420, the classical computing entity 10 provides the assertion circuit 420 to the controller 38 of the quantum computer 30. In an example embodiment, the classical computing entity 10 provides the assertion circuit 420 along with the program circuit 410. In an example embodiment, the assertion circuit 420 is stored in memory 822, 824 of the classical computing entity 10 and/or in a classical (e.g., semiconductor-based) memory of the controller 38, possibly in association with the program circuit 410 and/or the first portion thereof (e.g., the program channel).

### Technical Advantages

Conventional techniques for validating the noise status of a quantum computer tend to include the use of immediate assertions. These immediate assertions include performing a quantum circuit with a known result prior to beginning performance of a program circuit to determine whether to obtained result matches the known result. However, these forms of immediate assertions fail to provide insight into the noise status of a quantum computer while the quantum computer is performing a program circuit. Given the noisy nature of current quantum computers, validating the noise status of a quantum computer during the execution of a quantum program by the quantum computer may desired so as validate that the quantum computer was operating as intended during performance of the program circuit. Therefore, technical problems exist regarding monitoring the noise experienced by a quantum computer during performance of a program circuit.

Various embodiments provide technical solutions to these technical problems. For example, various embodiments provide for performance of concurrent assertions. The concurrent assertions are executed by the quantum computer while (e.g., overlapping in time) the quantum computer is performing at least a first portion of a quantum circuit. Thus, the results of the concurrent assertion provide a noise status of the quantum computer while the quantum computer was performing the program circuit.

In various embodiments, performing the concurrent assertion includes performing an assertion circuit concurrently with performance of the program circuit. In various embodiments, the assertion circuit comprises one or more gates that enact a single qubit unitary gate that approximates the performance of the first portion of the quantum circuit. Thus, the assertion circuit only requires one additional qubit (in addition to the system qubits used to perform the program circuit and at least one ancilla qubit) for performance thereof. Thus, the overhead added by including the assertion circuit is low.

Moreover, the noise status determined by performance of the assertion circuit may be used to cease execution of the program circuit when the noise status indicates that the noise levels experienced by the quantum computer are too high, so as to prevent wasting of resources in completing a program circuit shot that will not yield usable results.

Various embodiments provide for the automated performance of immediate quantum assertions. Immediate quantum assertions provide insight as to whether the state of a group of qubits is of an expected class of quantum states at a particular point in a quantum program circuit. Thus, the automated performance of immediate quantum assertions enables the identification of particular points in a quantum program circuit where the quantum state of a group of qubits is not of the expected class of quantum states for that group of qubits at that particular point in the quantum program circuit. This information may be used to identify sources of noise, sources of gate infidelity, and/or other error sources in the operation of the quantum computer such that the error sources may be addressed and mitigated.

Therefore, various embodiments provide technical advantages to the technical fields of quantum computing and noise assessment in quantum computing.

### Example Classical Computing Entity

FIG. 8 provides an illustrative schematic representative of an example classical computing entity 10 that can be used in conjunction with embodiments of the present disclosure. As used herein, the term “classical” refers to semiconductor-based computing (e.g., semiconductor-based processing elements, semiconductor-based memory, and/or the like). In various embodiments, a classical computing entity 10 is configured to interface with a quantum computer 30. In various embodiments, the classical computing entity 10 is configured to interface with a quantum computer 30 so as to provide a program circuit and, possibly, an assertion circuit corresponding to a first portion of the program circuit to the quantum computer 30 for performance and/or storage thereof, enable the classical computing entity 10 to receive qubit measurements, and/or the like. For example, the classical computing entity 10 may be configured to communicate with the quantum computer 30 to allow a user (e.g., a human user or a program operating on the classical computing entity 10) to receive, display, analyze, and/or the like output from the quantum computer 30.

As shown in FIG. 8 a classical computing entity 10 can include an antenna 812, a transmitter 804 (e.g., radio), a receiver 806 (e.g., radio), and a processing device 808 that provides signals to and receives signals from the transmitter 804 and receiver 806, respectively. The signals provided to and received from the transmitter 804 and the receiver 806, respectively, may include signaling information/data in accordance with an air interface standard of applicable wireless systems to communicate with various entities, such as a quantum computer 30, other classical computing devices, and/or the like. In this regard, the classical computing entity 10 may be capable of operating with one or more air interface standards, communication protocols, modulation types, and access types.

For example, the classical computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the classical computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The classical computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the classical computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The classical computing entity 10 can also download changes, add-ons, and updates, for instance, to its firmware, software (e.g., including executable instructions, applications, program modules), and operating system.

In various embodiments, the classical computing entity 10 may comprise a network interface 820 for interfacing and/or communicating with the quantum computer 30 and/or other classical computing devices, for example. In various embodiments, the classical computing entity 10 and the quantum computer 30 may communicate via a direct wired and/or wireless connection and/or via one or more wired and/or wireless networks 20.

In various embodiments, the processing device 808 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, graphics processing units (GPUs), central processing units (CPUs), other processing devices and/or circuitry, and/or the like. The term circuitry may refer to an entirely hardware embodiment or a combination of hardware and computer program products.

The classical computing entity 10 may also comprise a user interface device comprising one or more user input/output interfaces (e.g., a display 816 and/or speaker/speaker driver coupled to a processing device 808 and a touch screen, keyboard, mouse, and/or microphone coupled to a processing device 808). For instance, the user output interface may be configured to provide an application, browser, user interface, interface, dashboard, screen, webpage, page, and/or similar words used herein interchangeably executing on and/or accessible via the classical computing entity 10 to cause display or audible presentation of information/data and for interaction therewith via one or more user input interfaces. The user input interface can comprise any of a number of devices allowing the classical computing entity 10 to receive data, such as a keypad 818 (hard or soft), a touch display, mouse, voice/speech or motion interfaces, scanners, readers, or other input device. In embodiments including a keypad 818, the keypad 818 can include (or cause display of) the conventional numeric (0-9) and related keys (#, *), and other keys used for operating the classical computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the classical computing entity 10 can collect information/data, user interaction/input, and/or the like.

The classical computing entity 10 can also include (classical) volatile storage or memory 822 and/or non-volatile storage or memory 824, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the classical computing entity 10 (e.g., such as the distribution function discriminator).

### CONCLUSION

Many modifications and other embodiments of the disclosure set forth herein will come to mind to one skilled in the art to which the disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for monitoring noise of a quantum computer while the quantum computer is operating, the method performed by at least one classical processor, the method comprising:
obtaining a program circuit to be executed by the quantum computer;
obtaining an assertion circuit comprising an assertion channel determined based at least on a first portion of the program circuit and a SWAP test;
causing execution of the first portion of the program circuit and the assertion circuit;
receiving ancilla qubit measurement results captured during the SWAP test;
processing the ancilla qubit measurement results to determine a noise status of the quantum computer; and
providing an indication of the noise status of the quantum computer.

2. The method of claim 1, wherein the assertion channel comprises a single qubit unitary gate that approximates performance of the first portion of the program circuit.

3. The method of claim 2, wherein the assertion channel is determined by:
obtaining a parameterized representation of the assertion channel;
initializing a set of parameters of the parameterized representation of the assertion channel;
determining a gradient of a diamond norm difference between the first portion of the program circuit and the parameterized representation of the assertion channel with respect to the set of parameters; and
modifying the set of parameters based at least in part on the gradient.

4. The method of claim 1, wherein the SWAP test comprises performing a first Hadamard gate on the ancilla qubit, performing a sequence of SWAP gates on the ancilla qubit, an assertion qubit on which the assertion channel was performed, and system qubits on which the first portion of the program circuit is performed, performing a second Hadamard gate on the ancilla qubit, and performing a measurement of the ancilla qubit.

5. The method of claim 1, wherein processing the ancilla qubit measurement results performing a statistical analysis of the ancilla qubit measurement results to determine whether the ancilla qubit measurement results are from a unimodal distribution or a bimodal distribution.

6. The method of claim 1, wherein processing the ancilla qubit measurement results comprises determining a confidence level of performance of the first portion of the program circuit based at least in part on the ancilla qubit measurement results.

7. The method of claim 1, wherein the noise status is an estimation of a noise level experienced by the quantum computer during performance of the first portion of the program circuit determined based at least in part on processing the ancilla qubit measurement results.

8. The method of claim 1, wherein the noise status is an indication of whether a confidence level of performance of the first portion of the program circuit that is determined based at least in part on the ancilla qubit measurement results satisfies a confidence threshold requirement.

9. The method of claim 1, wherein providing an indication of the noise status comprises at least one of:
transmitting a noise status message for receipt by a classical computing entity;
storing the noise status message in a classical memory;
causing display of a noise status indicator by a user interface;
continuing to cause performance of the program circuit when the noise status satisfies a confidence threshold requirement; or
causing performance of the program circuit to be interrupted when the noise status does not satisfy the confidence threshold requirement.

10. A method for determining an assertion circuit, the method performed by at least one classical processor, the method comprising:
obtaining a program circuit to be performed by a quantum computer;
obtaining a parameterized representation of an assertion channel;
initializing a set of parameters of the parameterized representation of the assertion channel;
determining a difference measure between a first portion of the program circuit and the parameterized representation of the assertion circuit based on the set parameters;
modifying the set of parameters based at least in part the difference measure; and
determining a sequence of gates performable by the quantum computer that enact the parameterized representation of the assertion channel with a final set of parameters.

11. The method of claim 10, wherein the determining of the difference measure and the modifying the set of parameters is performed iteratively until convergence criteria are met, the set of parameters when the convergence criteria are met being the final set of parameters.

12. The method of claim 10, wherein the difference measure is a diamond norm difference between the first portion of the program circuit and the parameterized representation of the assertion channel.

13. The method of claim 12, wherein modifying the set of parameters based at least in part on the difference measure comprises modifying the set of parameters based at least in part on a gradient of the diamond norm difference between the first portion of the program circuit and the parameterized representation of the assertion channel with respect to the set of parameters.

14. The method of claim 10, further comprising concatenating a SWAP test to the sequence of gates performable by the quantum computer that enact the parameterized representation of the assertion channel with the final set of parameters.

15. The method of claim 14, wherein the SWAP test comprises performing a first Hadamard gate on the ancilla qubit, performing a sequence of SWAP gates on the ancilla qubit, an assertion qubit on which the assertion channel was performed, and system qubits on which the first portion of the program circuit is performed, performing a second Hadamard gate on the ancilla qubit, and performing a measurement of the ancilla qubit.

16. The method of claim 10, wherein the assertion channel assertion comprises a single qubit unitary gate that approximates performance of the first portion of the program circuit.

17. A method for improving operation of a quantum computer, the method performed by at least one classical processor, the method comprising:
generating a modified program circuit based on a quantum program circuit to be executed by the quantum computer, one or more groups of check qubits, and one or more placeholders, the one or more groups of check qubits and the one or more placeholders identified in the quantum program circuit;
simulating a plurality of iterations of performing the modified program circuit to generate output probability distributions;
processing the output probability distributions to identify at least one immediate quantum assertion;
implementing the at least one immediate quantum assertion in the quantum program circuit;
causing the quantum computer to execute the quantum program circuit with the at least one immediate quantum assertion implemented therein;
receiving an output of executing the quantum program circuit; and
determining and providing an indication of assertion results based at least in part on the output of executing the quantum program circuit, wherein the indication of the assertion results identifies at least one of (a) at least one qubit having a quantum state of an expected quantum state class at a particular point in the execution of the quantum program circuit by the quantum computer or (b) at least one qubit having a quantum state that is not of the expected quantum state class at the particular point in the execution of the quantum program circuit by the quantum computer.

18. The method of claim 17, wherein implementing the at least one immediate quantum assertion in the quantum program circuit comprises inserting a measurement operation on at least one associated check qubit of the quantum program circuit at an associated placeholder in the quantum program circuit.

19. The method of claim 18, wherein the measurement operation is one of a direct measurement operation, an encoded measurement operation, or a projection measurement operation.

20. The method of claim 17, wherein the expected quantum state class is one of a classical quantum state, a uniform superposition state, or a cat entangled state and the immediate quantum assertion is associated with an assertion class corresponding to the expected quantum state class.
